(19) United States
(12) Patent Application Publication
(10) Pub. No.: US 2016/0340128 A1
(43) Pub. Date: Nov. 24, 2016

(54) CONVEYOR BELT SCRAPER

(71) Applicant: Tega Industries Limited, Kolkata (IN)

(72) Inventors: Kaushal KISHOR, Kolkata (IN); Arunlal PANIGRAHI, Kolkata (IN)

(73) Assignee: Tega Industries Limited, Kolkata (IN)

(21) Appl. No.: 15/107,302

(22) PCT Filed: Feb. 28, 2014
(86) PCT No.: PCT/IN2014/000133

§ 371 Date: Jun. 22, 2016

(30) Foreign Application Priority Data
Jan. 2, 2014 (IN) 6/KOL/2014

(51) Int. Cl. B65G 45/16

(52) U.S. Cl. CPC B65G 45/16; B65G 2201/04; B65G 2207/40

(57) ABSTRACT

A belt scraper for be conveyors suitable for mounting on the head pulley comprises blade subassemblies (2), a mounting structure (1) and two side mounting subassemblies (3) to around the whole assembly and provide translator adjustment motions in perpendicular directions. A torsion spring and a compression spring provided in each blade subassembly (2) provide automatic continuous adjustment of scraper blades and keep scraper blades in continuous contact with the belt surface. The torsion spring is given a pre-tension during the assembly of the blade subassembly (2). The compression spring forward three for automatically adjusting scraper blades for less wear.

### FIELD OF THE INVENTION

The present invention in general relates to belt scrapers used in bulk material handling belt conveyors and in particular to an improved belt scraper assembly which can be mounted on the head pulley so that the cleaned material falls close to the center of the chute. The scraper has segmented blade body and is capable of avoiding obstacles without producing any threat of damage to the belt surface.

### BACKGROUND OF THE INVENTION

Belt Scrapers are used in bulk material handling belt conveyors to avoid material carry back, reduce spillage and keep belts clean. Clean belts help prevent material build up on snub pulley and return idlers and increase their life, thereby reducing cleaning cost, downtime cost and miss-tracking of the belt.

In first generation counter-weight belt scraper, single blade design is made from thick rubber strip (wider than belt width) under the return belt and the counter weights are provided at the side of the belt scraper with a pivot point to provide contact with the belt. The initial load exerted on the belt is approximately 80-90 Kgs. With use, when the cleaning effectiveness reduces, the weight is gradually increased and can go up to 150 Kgs.

Cleaning efficiency is approximately 60-68% and it is necessary to increase counter weight load on a regular basis to counter the effect of blade wear. Such scrapers are not very effective and involve high maintenance.

Second generation fixed mount belt scrapers have segmented blades which are made of hard alloy steel with rubber cushion at the bottom of the blades. The blades are mounted on a steel tube having a both ends fixed mount. It does not have automatic adjustments against blade wear. It provides an inconsistent contact pressure, which is approximately 100-125 Kgs, to the belt.

Cleaning efficiency of such scrapers is approximately 70-85% and there is always, a need to raise the fixed mount on a regular basis to counter, blade wear. Such scrapers too are less effective and involve high maintenance.

Pneumatically operated third generation belt scrapers have segmented blades which are made of hard alloy steel with or without polymer cushion at the bottom of the blades. The blades are mounted on a steel tube with ratchet-and-pinion mounts which are adjusted through compressed air at 7-10 bars pneumatically. They provide inconsistent load of approximately 90-110 Kgs to the belt. Cleaning efficiency is approximately 75-85%. Moreover, there is a need to pump air periodically to maintain proper blade-to-belt contact due to drop in air pressure/leakage/chocking of air. Maintenance requirement is high.

In the fourth generation belt scrapers with shock absorbers, semi automatic adjustments are present to some extent. But there is a need for periodic manual adjustments against blade wearing every 3-4 weeks. This type of belt scrapers have segmented metallic blades with pivot point below the scraping edge mounted on a steel tube with both ends mounted on rubber shock absorbers. It provides comparatively less load to the belt, which is approximately 24-80 Kgs. Cleaning efficiency is approximately 92-95%. It provides less consistency in heavy duty, high speed, vibration and bi-directional belt operation applications.

Above mentioned scrapers of the prior art are all installed at a position off the head pulley. But cleaning at this position causes the material to accumulate along the chute wall and eventually cover the scraper itself. It is always desirable that the cleaned material should move with the main materials flow which takes place close to the centre of the chute. There are a few scrapers made to scrap the material from the belt surface on the head pulley itself, but these belt scrapers are not as efficient as the scrapers installed off the head pulley. Clearly, the above mentioned conventional belt scraper assemblies are far from the desired scrapper and suffer from one problem or the other while in operation.

Accordingly there is a long felt need to design a belt scraper assembly which ensures that the cleaned material falls close to the center of the chute, efficient belt cleaning, automatic adjustment of the blades, lesser wear out rate of the blades and no material build up. It also must achieve size reduction and be adapted to easy installation, suitable for different belt speeds and reduce maintenance costs. It should be suitable for various types of material and operating in corrosive environment and provide easy joining of sub-assemblies.

The present invention meets the aforesaid long felt needs.

All throughout the specification including the claims, the words “conveyor belt”, “scraper blade” “scraper holding arm”, “torsion spring”, “compression spring”, “lead screw”, “washer”, “blade”, “blade tip”, “blade tip assembly”, “spring”, “fasteners” “hinge assembly”, “lock”, “pin”, “bellow”, “angle” and “nut” are to be interpreted in the broadest sense of the respective terms and includes all similar items in the field known by other terms, as may be clear to persons skilled in the art. Restriction/limitation, if any, referred to in the specification, is solely by way of example and understanding the present invention.

### OBJECTS OF THE INVENTION

It is the principal object of the present invention to provide an improved belt scraper assembly for belt conveyors which ensures efficient cleaning of the belt surface, which is capable of being installed on the head pulley and which ensures avoidance of the blade tip getting damaged by a mechanical fastener if attached with the belt Such mechanical fasteners are used to join two belt surfaces.

It is another object of the present invention to eliminate misalignment of blades. Misalignment in the blades reduces the cleaning efficiency of the scraper as it allows material to pass between two blades. The present invention ensures minimum misalignment with easy assembly process.

It is another object of the present invention to ensure automatic adjustment of the blades, lesser blade wear rate and no material build up.

It is a further object of the present invention to provide an improved belt scraper assembly for belt conveyors which ensures size and weight reduction and easy installation:

It is another object of the present invention to provide an improved belt scraper assembly for belt conveyor which is suitable for variable belt speeds and reduces maintenance costs.

It is yet another object of the present invention to provide an improved belt scraper assembly for belt conveyor which is suitable for variable materials and is suitable for working in corrosive environment.

It is a further object of the present invention to provide an improved belt scraper assembly for belt conveyors which is suitable for used up to 200° C. ambient temperature.

It is a further object of the present invention to provide an improved belt scraper assembly for belt conveyors which ensures easy joining of the subassemblies.

How the foregoing objects are achieved and other aspects of the present invention will be clear from the following description which is purely by way of understanding and not by way of any sort of limitation.

### SUMMARY OF THE INVENTION

Accordingly, the present invention provides an improved be t scraper assembly for belt conveyors suitable for mounting on the head pulley comprising of a plurality of blade subassemblies, a mounting structure and two side-mounting subassemblies to ground the whole assembly and provide translatory motions in perpendicular directions. The assembly is provided with a torsion spring for providing the flipping action required to disengage the blades in case a blade fastener or protrusion in the belt surface appears and for preventing the blade tip from being damaged. The assembly, also has a compression spring to provide automatic continuous adjustment of the scraper blades to keep the blades in contact with the belt surface in the event of the blades wearing out.

In accordance with preferred embodiments of the belt scraper assembly of the present invention:
said blade subassembly consists of blade tip, blade body, a torsion spring, a plurality of bushes, slotted pins, a rivet, a blade body pin, a compression spring and a cap;
said blade tip is made of high resistant metal brazed on a plate of metal body;
said torsion spring has legs at both ends of the spring which are clamped by said slotted pins at both the ends;
said slotted pin is placed within hole of said blade block element, clamped to one leg of said torsion spring which is also placed within hole and then fixed to the blade block element whereas said slotted pin is clamped to the other leg of said torsion spring and then fixed to the blade body, the arrangement providing a fully covered torsion spring action to the assembly;
said torsion spring is provided with a pre-tension during the assembly of said blade subassembly;
said mounting structure is connected to two side mounting subassemblies at both the ends of the structure which ground the structure;
said side mounting subassembly is provided with arrangement to move the scraper in two perpendicular directions;
all the components of the assembly can h tend temperature of up to 200° C. ambient;
all the blades are aligned at a uniform angle throughout the life of the scraper;
said uniform angle of alignment of the blades is achieved by pre-tensioning of torsion spring and by the design of the blade element acting as a stopper.

### BRIEF DESCRIPTION OF THE ACCOMPANYING DRAWINGS

The nature and scope of the present invention will be better understood from the accompanying drawings, which are by way of illustration of a preferred embodiment and not by way of any sort of limitation. In the accompanying drawings,

FIG. 1 is the side view of the complete scraper assembly.

FIG. 2 is the front view of the complete scraper assembly.

FIG. 3 is an isometric view of the side mounting subassembly of the scraper.

FIGS. 4 is an side view of the side mounting subassembly of FIG. 3 indicating the connections between its different components.

FIG. 5 is an isometric view of the side mounting subassembly indicating connections between different components.

FIGS. 6a to 6c are three isometric views of different components of the side mounting subassembly.

FIG. 7 is an isometric view of the blade subassembly.

FIG. 8 is a blown up isometric view of the blade subassembly which is connected to the angle, showing its important components.

FIG. 9 is the front view of the blade subassembly of FIG. 7 showing the connections between its various components.

FIG. 10 is an isometric view of different components of the blade subassembly.

FIG. 11 is an isometric view of the blade body and the blade body pin.

### DETAILED DESCRIPTION OF THE INVENTION

The following describes a preferred embodiment of the present invention, which is purely for the sake of understanding the performance of the invention, and not by way of any sort of limitation.

Desired features of the belt scraper assembly according to the
present invention:

| | |
|---|---|
| a. Eliminate misalignment of | b. Reduce maintenance cost |
| blades | |
| c. Automatic adjustment of the | d. Suitable for various belt speeds |
| blades | |
| e. Lower blade wear rate | f. Suitable for various materials |
| g. No material buildup | h. Suitable for use up to 200° C. |
| | ambient |
| i. Reduced size | j. Suitable for use in corrosive |
| | environment |
| k. Reduced weight | l. Alteration of place of installation |
| m. Easy installation | n. Easy joining of the sub assemblies |

The present invention brings all the above changes in a way never done before. The blade elements in the present invention have two degrees of flexibility, one along the belt for obstacle avoidance and another perpendicular to the belt surface for automatic adjustment. Both the flexibilities result in scraper disengagement in case the pressure between the blade and the belt increases.

For understanding the invention better, reference will now be made to the following preferred embodiment of the invention, which is illustrated in the accompanying drawings.

In the figures like reference numerals represent like features.

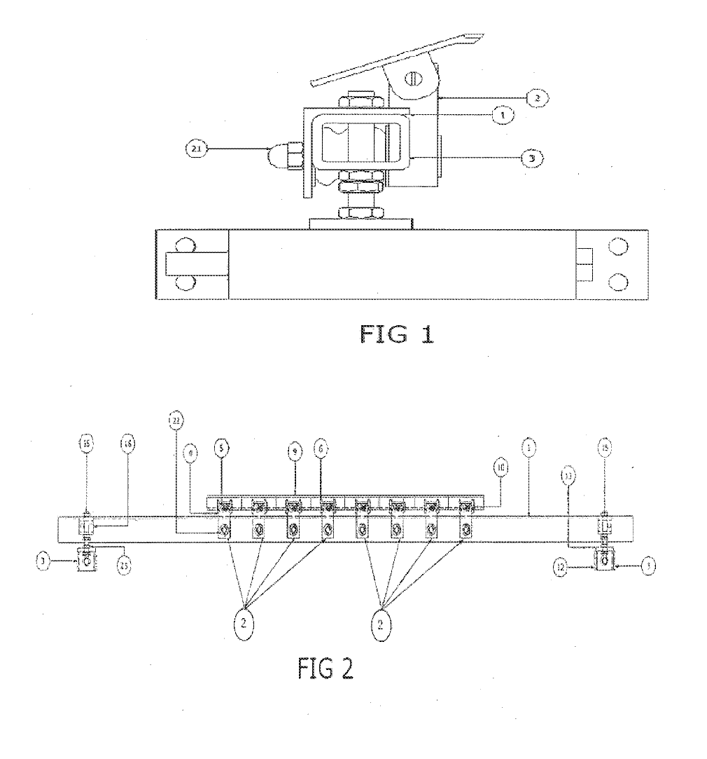

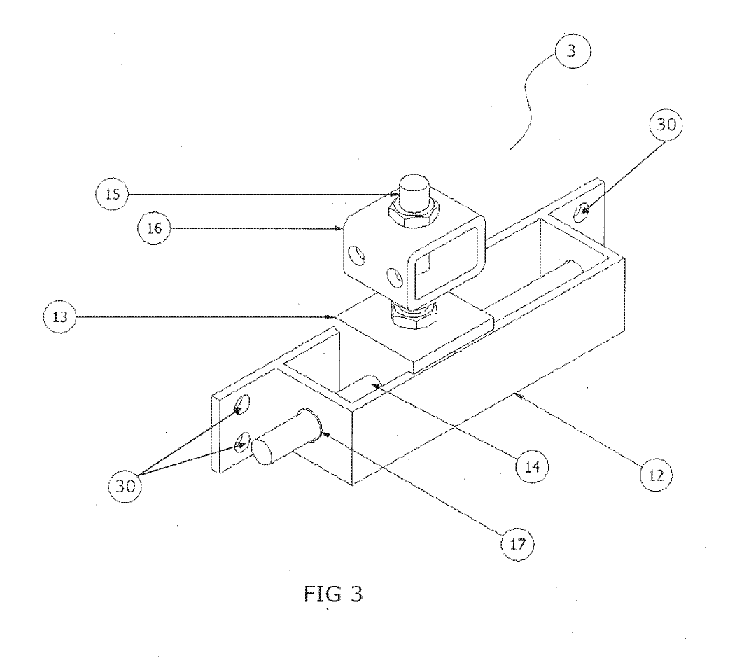

Turning first to FIG. 1, it shows the side view of the complete scraper assembly and the relative positions of the blade subassembly (2), angle (1) and side mounting subassembly (3), which is best shown in 5, FIG. 3.

FIG. 2 shows the front view of the complete scraper assembly. It shows the connection of a plurality of blade subassemblies (2) with the angle (1) and the connection of angle (1) with the side mounting sub assembly (3) at the two ends.

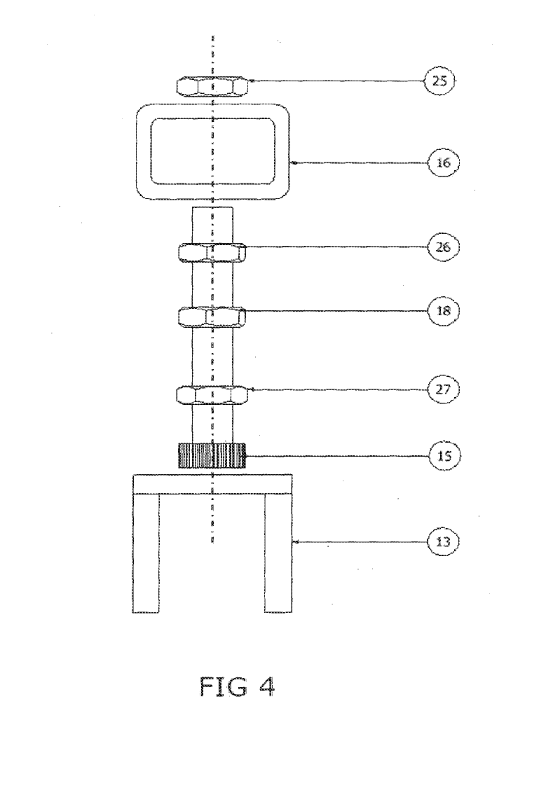

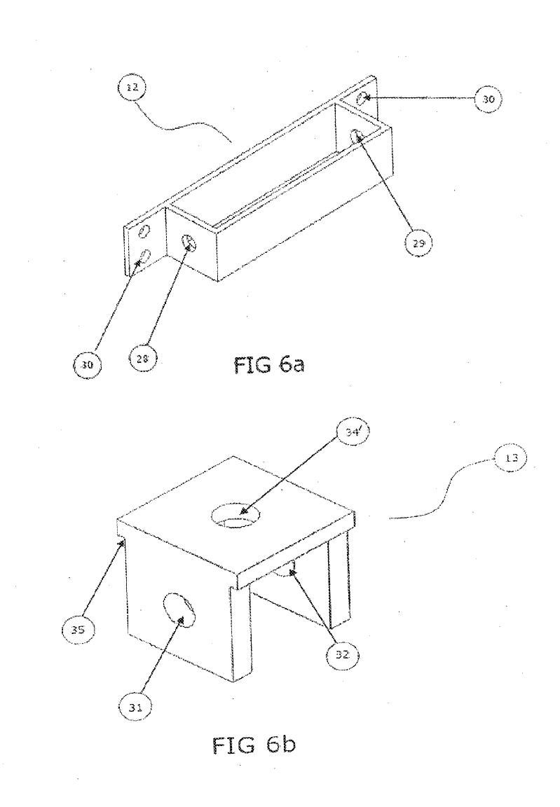

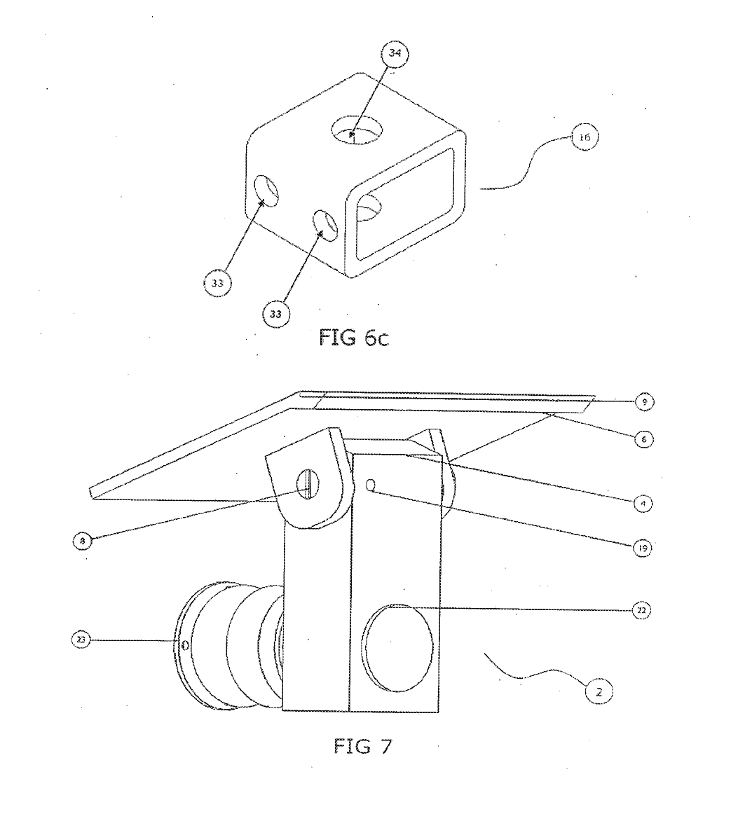

FIG. 3 shows the isometric view of the side mounting subassembly (3). Reference is also made here to FIGS. 6a, 6b and 6c for detailing. Subassembly (3) incorporates lead screws (15) and (14) which allow its movement in two perpendicular directions. Frame (16) is used to attach angle (1) with the side mounting subassembly (3). Main frame (12) is bolted to the chute periphery using holes (30) for fixing the whole scraper assembly. Main frame (12) also has two bolt holes (28, 29) on two opposing side walls (best shown in FIG. 6a). A rectangular block (13) is connected with main frame (12) using fastener (14) which goes through the holes (31, 32, 28 and 29), best shown in FIGS. 6(a) and 6(b), which are present on rectangular block and main frame respectively. A circlip (17) is used to hold the fastener (14) at its position and lock its translatory motion, allowing only rotatory motion. An elongated body part or edge (35) of rectangular block (13) slides over a top surface part of the main frame (12). Frame (16) is connected to the rectangular block (13) using patches (25, 26, 18 and 27), best shown in FIG. 4. The linear motion to the frame (16) is provided by using the lead screw principle.

FIG. 4 shows the side view of the side mounting subassembly (3) indicating the connection between its different components, namely frame (16), patches (25, 26, 18, 27) and rectangular block (13).

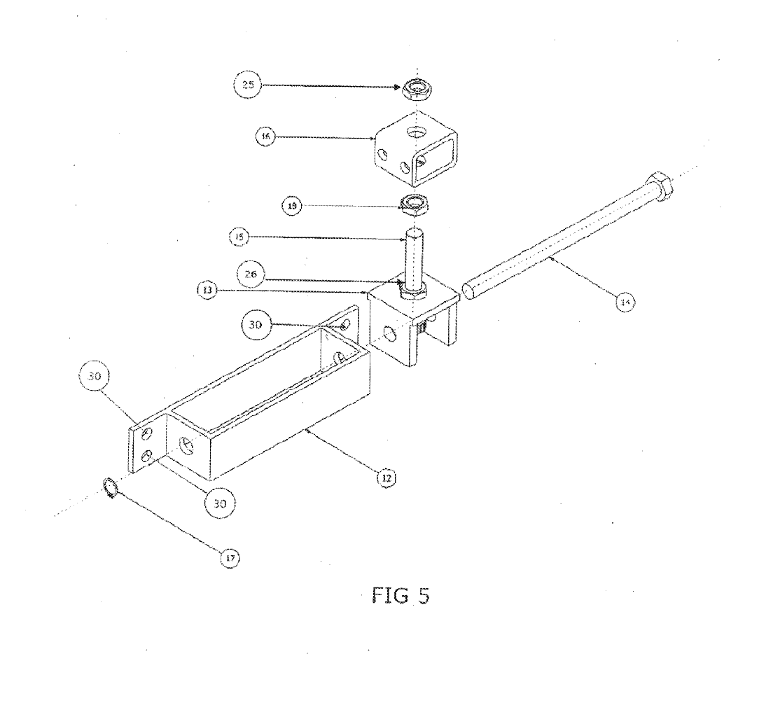

FIG. 5 shows an isometric blown up view of the side mounting subassembly (3) indicating connections between its different components, namely frame (16), patches (25, 26, 18 and 27), rectangular block (13), main frame (12), fastener (14), circlip (17) and lead screw (15).

FIGS. 6a to 6c show isometric views of different components of the side mounting subassembly with their detailing.

FIG. 6a shows the main frame (12) which is adapted to be fixed with the chute periphery using holes (30) for grounding the whole scraper assembly. The elongated body of main frame (12) contains bolt holes (28, 29) on its two opposing side faces, through which the fastener (14) passes.

FIG. 6b shows the rectangular block (13), an edge (35) of which slides over a top surface of the main frame (12). The block has holes (31, 32) on its two vertical sidewalk through which said fastener (14) passes. The top face of the rectangular block (13) has a hole (34′) through which lead screw (15) passes.

FIG. 6c shows details of constructional features of frame (16). The bolt holes (33) are present on one sidewall of the frame (16). The angle (1) is connected with frame (16) by bolting through these holes (33). The top and bottom surfaces have bolt holes (34) through which lead screw (15) passes.

The side mounting subassembly (3) is connected to the angle (1). There are two such side mounting subassemblies at both ends of the angle (1). Angle (1) contains a series of holes to hold the plurality of blade subassemblies (2), best shown in FIG. 2. The angle (1) ensures automatic adjustment of the blades.

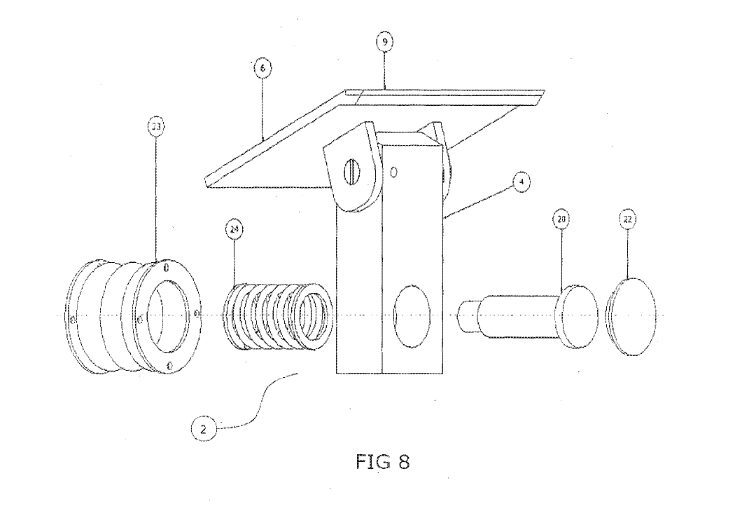

Reference is now made to FIGS. 7 and 8. FIG. 7 shows an isometric view of the blade subassembly (2), while FIG. 8 gives the details of its components primarily related to compression spring (24) and its assembly. A plurality of blade subassemblies is connected to angle (1) using blade body pins (20) and caps (22). Pin (20) passes through a vertical blade block element (4), compression spring (24), a spring cover (23) and the angle 1, not shown in these figures. Cap (22) is used to close the hole in blade block element (4).

With this arrangement, the compression spring (24) provides the required suspension to the blade block element (4). It also provides the forward force for automatic continuous adjustment of the scraper blades and for keeping the blades in contact with the belt surface even as the blades wear out. This eliminates the need of frequent maintenance required to keep adjusting the scraper to compensate for the wear of the blades.

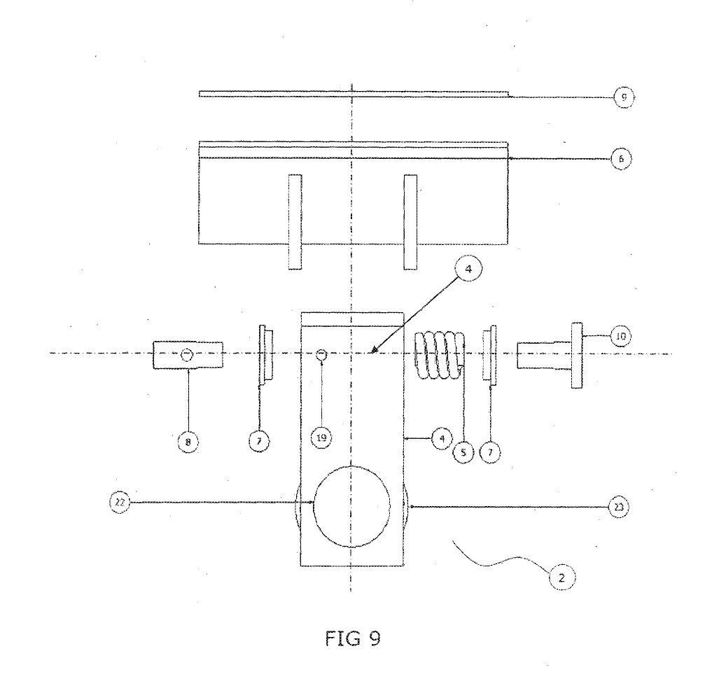

Coming to FIGS. 9, 10 and 11, blade block element (4) is connected to blade body (6) using pins (8) and (10) respectively. These three drawings collectively show the connections between different components of the blade assembly used mainly to connect the two springs, namely the torsion spring (5) and the compression spring (28) with the blade body.

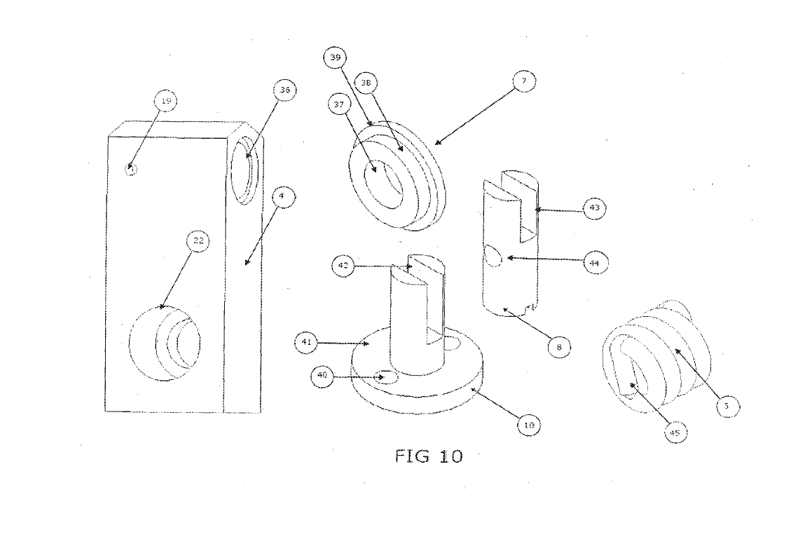

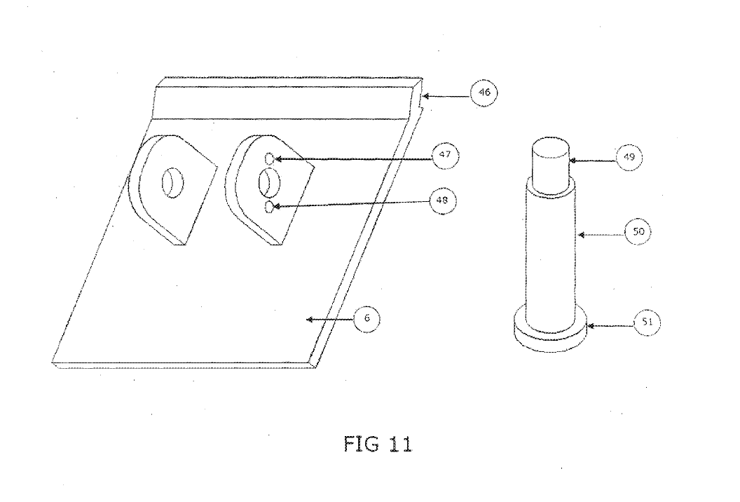

Bush (7) is a covering provided at both ends for the hole (36) on block element (4), best shown in FIG. 10. Bush (7), which allows proper rotation of blade body (6), has a sealing outer rim (39), second rim (38) and internal hole (37) which accommodates pins (8) and (10). Torsion spring (5) is placed inside hole (36) of the blade block (4). Torsion spring (5) is provided with legs (45) which are present at both ends of the spring. One leg is clamped in the gap (42) of pin (10) and the other leg is clamped in the gap (43) of pin (8). Pin (8) is riveted to blade block (4) using hole (19) on the blade block element (4). Pin (10) is connected to the blade body (6) by screwing at the points (47) and (48) on the blade body, best shown in FIG. 11, and holes (40) on the pin (10). The blade tip (9) is attached at the front part (46) of the blade body (6) through brazing or similar means. The blade tip (9) is made of a hard and wear-resistant material. In the present case it is a tungsten carbide tip brazed on a plate named here as the blade body. Before assembly, hole (44) on the pin (8) lags 10 degrees with respect to hole (19) on the blade block element (4). This is achieved by having a 10 degrees difference in the two legs (45) of the torsion spring (5). At the time of assembling, the pin (8) is rotated by 10 degrees such that hole (44) coincides with hole (19). While doing so one of the legs (45) of torsion spring (5) clamped by pin (8) is also twisted giving a pre-tension to the torsion spring i.e. the torsion spring has already been rotated by 10 degrees before the assembly is put into operation. This pre-tensioning enables use of a torsion spring having a lower wire diameter, consequently reducing the overall dimension of the whole assembly because all other dimensions are based on the dimension of the torsion spring. Secondly, the pre-tensioning rotates the blade body (6) till the edge of the blade block element (4) provides a uniform angle to all the blade bodies in the whole assembly (irrespective of the clamping clearance of the torsion spring).

After clamping of the two ends of the torsion spring (5) by pins (8) and (10), pin (8) is twisted to provide a pre-tensioning force to the torsion spring (5). Pin (8) is rotated till hole (19) on blade block element (4) and hole (44) on pin (8) coincide and a rivet is placed in the two concentric holes. This results in a uniform angle for all the blades and eliminates the chance of misalignment at the time of assembly. So the uniform angle of alignment of the blades is achieved by pre-tensioning of torsion spring and by the design of the blade element acting as a stopper. All the blades are aligned at a uniform angle throughout the life of the scraper.

The torsion spring (5) provides the flipping action required to disengage the blades in case a blade fastener or protrusion in the belt surface appears. This feature protects both the belt and the blade tip from being damaged.

From the foregoing description and the appended claims it should be clear that all the desired objectives of the present invention are fulfilled.

The present invention has been described with reference to some drawings and preferred embodiments, purely for the sake of understanding and not by way of any limitation and the present invention includes all legitimate developments within the scope of what has been described hereinbefore and claimed in the appended claims.

1. A belt scraper assembly for belt conveyors suitable for mounting on the head pulley, the belt assembly comprising of a plurality of blade subassemblies, a mounting structure and two side-mounting subassemblies to ground the whole assembly and provide translatory motions in perpendicular directions, said assembly being provided with a torsion spring for providing the flipping action required to disengage the blades in case a blade fastener or protrusion in the belt surface appears and for preventing the blade tip from being damaged, the assembly also having a compression spring to provide automatic continuous adjustment of the scraper blades to keep the blades in contact with the belt surface in the event of the blades wearing out.

2. The belt scraper assembly as claimed in claim 1, wherein said blade subassembly consists of blade tip, blade body, a torsion spring, a plurality of bushes, slotted pins, a rivet, a blade body pin, a compression spring and a cap.

3. The belt scraper assembly as claimed in claim 2, wherein said blade tip is made of high wear resistant metal brazed on a plate of metal body.

4. The belt scraper assembly as claimed in claim 2, wherein said torsion spring has legs at both ends of the spring which are clamped by said slotted pins at both the ends.

5. The belt scraper assembly as claimed in claim 4, wherein said slotted pin is placed within hole of said blade block element, clamped to one leg of said torsion spring which is also placed within hole and then fixed to the blade block element whereas said slotted pin is clamped to the other leg of said torsion spring and then fixed to the blade body, the arrangement providing a fully covered torsion spring action to the assembly.

6. The belt scraper assembly as claimed in claim 2, wherein said torsion spring is provided with a pre-tension during the assembly of said blade subassembly.

7. The belt scraper assembly as claimed in claim 1, wherein said mounting structure is connected to two side mounting subassemblies at both the ends of the structure which ground the structure.

8. The belt scraper assembly as claimed in claim 1, wherein said side mounting subassembly is provided with arrangement to move the scraper in two perpendicular directions.

9. The belt scraper assembly as claimed in claim 1, wherein all the components of the assembly can withstand temperature of up to 200° C. ambient.

10. The belt scraper assembly as claimed in claim 1, wherein all the blades are aligned at a uniform angle throughout the life of the scraper.

11. The belt scraper assembly as claimed in claim 1, wherein said uniform angle of alignment of the blades is achieved by pre-tensioning of torsion spring and by the design of the blade element acting as a stopper.
